(19) United States
(12) Patent Application Publication
(10) Pub. No.: US 2019/0016932 A1
(43) Pub. Date: Jan. 17, 2019

(54) LAMINATE

(71) Applicant: KABUSHIKI KAISHA TOYOTA JIDOSHOKKI, Kariya-shi (JP)

(72) Inventors: Hidenori MUNEKATA, Aichi-ken (JP); Yuya MARUYAMA, Aichi-ken (JP); Hisashi MURAMATSU, Aichi-ken (JP); Tetsuya MITSUOKA, Aichi-ken (JP)

(73) Assignee: KABUSHIKI KAISHA TOYOTA JIDOSHOKKI, Kariya-shi (JP)

(21) Appl. No.: 16/031,073

(22) Filed: Jul. 10, 2018

(30) Foreign Application Priority Data
Jul. 14, 2017 (JP) 2017-138623

(51) Int. Cl. C09J 133/14

(52) U.S. Cl. CPC C09J 133/14

(57) ABSTRACT

A laminate includes a resin substrate, an intermediate layer disposed on a surface of the resin substrate, and a silicon oxide layer disposed on a surface of the intermediate layer. The intermediate layer is formed by curing a composition containing a Si-free compound containing a (meth)acrylic group and a siloxane compound containing a (meth)acrylic group. A concentration of Si is higher on a silicon oxide layer side than a concentration of Si on a resin substrate side in the intermediate layer.

### CROSS-REFERENCE TO RELATED APPLICATION

The present application claims priority to Japanese Patent Application No. 2017-138623, filed on Jul. 14, 2017, the contents of which are entirely incorporated herein by reference.

### BACKGROUND ART

The present disclosure relates to a laminate for use as a vehicle member such as a resin window.

A resin material such as polycarbonate is used as a material for a wide variety of members including vehicle members, taking advantage of the characteristics of smaller specific gravity and lighter weight than inorganic glass, easy processability, and being resistant to impact. On the other hand, the resin material is disadvantageous in that its surface is susceptible to scratching and loses glossiness and transparency, susceptible to organic solvents, inferior in weather resistance (for example, light stability against ultraviolet light or the like) and heat resistance, or the like. Windowpanes for automobiles and the like are often exposed to sunlight for a long period of time. Therefore, when a resin material is used for an automobile member, it is necessary to impart abrasion resistance and weather resistance to the resin material by coating the surface with a protective layer or the like.

As a conventional art for imparting abrasion resistance and weather resistance to a resin material, there is known a method in which an acrylic resin layer is formed on the surface of a resin substrate, and a silicone layer is formed on the surface of the acrylic resin layer, and then a silicon oxide layer is formed on the surface of the silicone layer. For example, in Japanese Patent Application Publication No. 2012-224077, a primer composition containing an acrylic resin is applied on a polycarbonate plate and cured to form an acrylic resin layer, and a silicone coating composition containing a siloxane compound is applied thereon and cured to form a silicone layer, and further an organosilicon compound is plasma-polymerized thereon to form a hard film containing silicon and oxygen (hereinafter referred to as a silicon oxide layer).

Here, the roles of the three layers formed on the surface of the resin substrate in the conventional art will be described. First, the acrylic resin layer has a function of improving adhesion between the resin substrate and the silicone layer, as well as protective function for the resin substrate. Next, the silicone layer has a function of improving adhesion between the acrylic resin layer and the silicon oxide layer, as well as protective function for the resin substrate and the acrylic resin layer. Then, the silicon oxide layer has a function of achieving a high level of abrasion resistance due to its high hardness.

In the above-described conventional art, a protective layer satisfying abrasion resistance and weather resistance is produced by forming three layers of an acrylic resin layer, a silicone layer and a silicon oxide layer on the surface of a resin substrate. However, each layer requires its specific work and time for forming. Therefore, from the viewpoint of production efficiency, the conventional art is not necessarily a satisfactory production method.

The present disclosure has been made in view of such circumstances, and an object is to provide a resin substrate having two layers disposed on the surface of the resin substrate as a protective layer.

### SUMMARY

In accordance with an aspect of the present disclosure, there is provided a laminate that includes a resin substrate, an intermediate layer disposed on a surface of the resin substrate, and a silicon oxide layer disposed on a surface of the intermediate layer. The intermediate layer is formed by curing a composition containing a Si-free compound containing a (meth)acrylic group and a siloxane compound containing a (meth)acrylic group. A concentration of Si is higher on a silicon oxide layer side than a concentration of Si on a resin substrate side in the intermediate layer.

In accordance with another aspect of the present disclosure, there is provided a vehicle member that includes a laminate including a resin substrate, an intermediate layer disposed on a surface of the resin substrate, and a silicon oxide layer disposed on a surface of the intermediate layer. The intermediate layer is formed by curing a composition containing a Si-free compound containing a (meth)acrylic group and a siloxane compound containing a (meth)acrylic group. A concentration of Si is higher on a silicon oxide layer side than a concentration of Si on a resin substrate side in the intermediate layer,

In accordance with another aspect of the present disclosure, there is provided a composition that contains a Si-free compound containing two or more (meth)acrylic groups, and an isocyanuric ring or a carbonate structure; and a siloxane compound having a basic skeleton represented by General Formula (4):

(CH₂═CRCO₂C₃H₆SiO_{0.5×3})ₗ(CH₃SiO_{0.5×3})ₘ(SiO_{0.5×4})ₙ (4)

wherein R is independently H or CH₃, the sum of I, m and n is 1, 0.1≤I ≤1, 0≤m≤0.9, and 0≤n≤0.5. The composition contains 40 to 95% by mass of the Si-free compound and 5 to 60% by mass of the siloxane compound, based on a total amount of the Si-free compound and the siloxane compound.

Other aspects and advantages of the disclosure will become apparent from the following description, taken in conjunction with the accompanying drawing, illustrating by way of example the principles of the disclosure.

### BRIEF DESCRIPTION OF THE DRAWING

The disclosure, together with objects and advantages thereof, may best be understood by reference to the following description of the embodiments together with the accompanying drawing in which:

FIG. 1 is a schematic side view of a laminate of the present disclosure.

### DETAILED DESCRIPTION OF THE EMBODIMENTS

Embodiments for carrying out the present disclosure will now be described. Unless otherwise specified, the numerical range “a to b” described in this disclosure includes a lower limit “a” and an upper limit “b” within the range. The numerical range may be constituted by arbitrarily combining these upper and lower limit values, including the numerical values listed in examples of the present disclosure. Further, a numerical value arbitrarily selected from these numerical ranges may be taken as a new upper or lower limit value. In the present disclosure, acrylic group and methacrylic group are generally represented as (meth)acrylic group, and acrylate and methacrylate are generally represented as (meth)acrylate. The acrylic group means CH₂═CHCO, and the methacrylic group means CH₂═CCH₃CO.

The laminate of the present disclosure is a laminate that includes a resin substrate, an intermediate layer disposed on a surface of the resin substrate, and a silicon oxide layer disposed on a surface of the intermediate layer. The intermediate layer of the laminate is obtained by curing a composition (hereinafter sometimes referred to “the composition of the present disclosure”) containing a Si-free compound containing a (meth)acrylic group (hereinafter sometimes referred to simply as “Si-free compound”) and a siloxane compound containing a (meth)acrylic group (hereinafter sometimes referred to simply as “siloxane compound”), and a concentration of Si is higher on the silicon oxide layer side than that on the resin substrate side in the intermediate layer.

Examples of the resin of the resin substrate may include polycarbonate, polymethyl methacrylate, polyethylene terephthalate, polyvinyl chloride, epoxy resins, polyurethane, and the like. In particular, polycarbonate having sufficient transparency and impact resistances is suitable as a resin for the vehicle member such as a windowpane.

The intermediate layer is obtained by curing a composition containing a Si-free compound containing a (meth)acrylic group and a siloxane compound containing a (meth)acrylic group, and the Si concentration on the silicon oxide layer side in the intermediate layer is higher than that on the resin substrate side. The relatively high Si concentration on the silicon oxide layer side in the intermediate layer indicates that the existence ratio of Si—O—Si derived from a siloxane bond is high on the silicon oxide layer side in the intermediate layer. Therefore, the surface on the silicon oxide layer side in the intermediate layer and the silicon oxide layer both contain Si—O and thus have high affinity and excellent adhesion. In addition, since the Si concentration on the resin substrate side in the intermediate layer is relatively low, it can be said that the existence ratio of C, H, O, and the like, other than Si, is relatively high. Since the surface on the resin substrate side in the intermediate layer and the resin substrate have similar compositions, and thus have high affinity and excellent adhesion.

From a functional point of view, it can be said that two roles as the acrylic resin layer and the silicone layer of the conventional art are played by the single intermediate layer. Also, the intermediate layer can be said to have a Si concentration gradient in which the concentration of Si gradually increases from the resin substrate side toward the silicon oxide layer side.

The intermediate layer is obtained by curing a composition containing a Si-free compound containing a (meth)acrylic group and a siloxane compound containing a (meth)acrylic group. Here, it is considered that, when a composition containing a Si-free compound containing a (meth)acrylic group and a siloxane compound containing a (meth)acrylic group is disposed on a resin substrate, components are biased inside the composition, due to factors such as affinity with a resin substrate and differences in the surface free energy of each compound in the composition. Specifically, it is considered that the Si-free compound containing a (meth)acrylic group having an excellent affinity with the resin substrate migrates to the resin substrate side, whereas the siloxane compound containing a (meth)acrylic group migrates toward the surface side of the composition on the side opposite to the resin substrate side.

Here, curing is performed by polymerization of (meth)acrylic groups. In the composition disposed on the resin substrate, since the components are biased, the polymerization reaction proceeds in this state to form the intermediate layer. As a result, the feature of the present disclosure that the concentration of Si on the silicon oxide layer side in the intermediate layer is higher than that on the resin substrate side arises. In the intermediate layer, since the affinity between the Si-free compound containing a (meth)acrylic group and the siloxane compound containing a (meth)acrylic group is high, they do not phase-separate from each other. Therefore, curing proceeds by copolymerization. As a result, there is no interface in the intermediate layer itself, and the intermediate layer consists of a single layer.

The Si concentration on the silicon oxide layer side in the intermediate layer is higher than that on the resin substrate side. More specifically, the Si concentration of the surface on the silicon oxide layer side in the intermediate layer is higher than the theoretical Si concentration in the intermediate layer. The Si concentration of the surface on the silicon oxide layer side in the intermediate layer is preferably 2 to 10 times, more preferably 3 to 8 times, and further preferably 4 to 7 times the theoretical Si concentration in the intermediate layer. Further, when the surface on the silicon oxide layer side in the intermediate layer is subjected to element analysis by X-ray photoelectron spectroscopy for C, O, N, and Si, the ratio of Si element to total elements of C, O, N, and Si is preferably 5% or more, the ratio of Si element is more preferably 7% or more, and the ratio of Si element is further preferably 10% or more. Examples of the upper limit of the ratio of Si element include 15% and 20%.

As the Si-free compound containing a (meth)acrylic group, a compound containing two or more (meth)acrylic groups is preferable, and a compound containing two to three (meth)acrylic groups is more preferable, from the viewpoint of forming a complicated polymerized state. From the viewpoint of affinity with a resin material, a compound containing an isocyanuric ring or a carbonate structure is preferred. Compounds having these chemical structures are considered to be particularly excellent in affinity with polycarbonate.

Specific examples of the Si-free compound include isocyanuric ring-containing urethane (meth)acrylate compounds represented by the following General Formula (1):

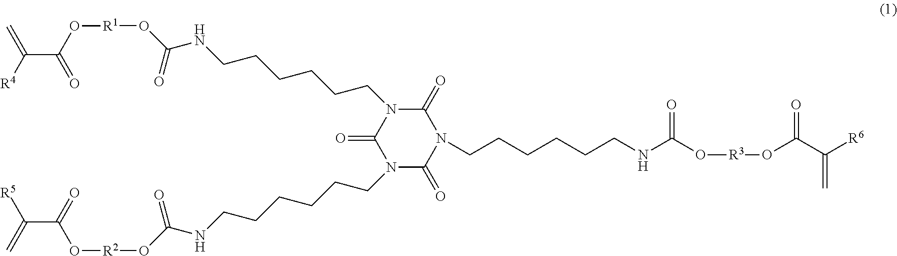

In General Formula (1), R¹, R² and R³ each independently represent a divalent organic group having 2 to 10 carbon atoms, and R⁴, R⁵ and R⁶ each independently represent a hydrogen atom or a methyl group.

The divalent organic group having 2 to 10 carbon atoms is preferably an alkylene group having 2 to 4 carbon atoms, such as an ethylene group, a trimethylene group, a propylene group, and a tetramethylene group. The compound of General Formula (1) also includes compounds modified with ε-caprolactone, and in this case, the divalent organic group having 2 to 10 carbon atoms includes —COCH₂CH₂CH₂CH₂CH₂— or —OCOCH₂CH₂CH₂CH₂CH₂—. Compounds in which R¹, R² and R³ are all tetramethylene groups are particularly preferable.

In General Formula (1), R⁴, R⁵ and R⁶ each independently represent a hydrogen atom or a methyl group. Here, compounds in which R⁴, R⁵ and R⁶ are all hydrogen atoms are particularly preferable, from the viewpoint of its excellent curability.

The compound of General Formula (1) is synthesized by an addition reaction of a nurate trimer of hexamethylene diisocyanate and a hydroxyalkyl (meth)acrylate or a caprolactone-modified product thereof. Although this addition reaction can be performed without catalyst, in order to efficiently proceed the reaction, it is preferable to use a catalyst including a tin-based catalyst such as dibutyltin dilaurate or an amine-based catalyst such as triethylamine.

Specific examples of the Si-free compound include isocyanuric ring-containing tri(meth)acrylate compounds having no urethane bond, represented by the following General Formula (2):

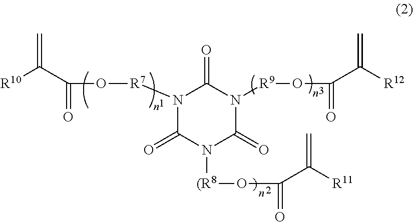

In General Formula (2), R⁷, R⁸ and R⁹ each independently represent a divalent organic group having 2 to 10 carbon atoms, R¹⁰, R¹¹ and R¹² each independently represent a hydrogen atom or a methyl group, n¹, n² and n³ each independently represent a number from 1 to 3, and a sum of n¹, n² and n³ is 3 to 9.

In General Formula (2), the divalent organic group having 2 to 10 carbon atoms is preferably an alkylene group having 2 to 4 carbon atoms, such as an ethylene group, a trimethylene group, a propylene group, and a tetramethylene group. General formula (2) also includes compounds modified with ε-caprolactone, and in this case, the divalent organic group having 2 to 10 carbon atoms includes —COCH₂CH₂CH₂CH₂CH₂— or —OCOCH₂CH₂CH₂CH₂CH₂—. Compounds in which R⁷, R⁸ and R⁹ are all ethylene groups are particularly preferable, since a film having particularly excellent abrasion resistance and weather resistance can be obtained.

In General Formula (2), R¹⁰, R¹¹ and R¹² each independently represent a hydrogen atom or a methyl group. Here, compounds in which R¹⁰, R¹¹ and R¹² are all hydrogen atoms are particularly preferable, from the viewpoint of excellent curability.

In General Formula (2), n¹, n² and n³ each independently represent a number from 1 to 3. However, the sum of n¹, n² and n³ is 3 to 9. n¹, n² and n³ are preferably 1, and the sum of n¹, n² and n³ is preferably 3.

The compound of General Formula (2) is preferably produced by reacting an alkylene oxide adduct of isocyanuric acid with (meth)acrylic acid. The sum of n¹, n² and n³ represents the average number of moles of alkylene oxide added per molecule of the compound of General Formula (2).

Specific examples of the Si-free compound include carbonate structure-containing (meth)acrylate compounds represented by the following General Formula (3):

CH₂═CRCO₂[-LOCOO]ₙ-L-OCOCR═CH₂ (3)

wherein Rs are each independently H or CH₃, Ls are each independently a divalent hydrocarbon having two or more carbon atoms, and n is an integer of 1 or more.

In General Formula (3), Rs may be either H or CH₃, but the compounds in which two Rs are H are preferable.

In General Formula (3), examples of Ls each independently include an alkylene group, a cyclic alkylene group, an alkylene group containing a cyclic alkyl, an aromatic group, and an alkylene group containing an aromatic group. The alkylene group is preferably one having 2 to 8 carbon atoms, and more preferably one having 4 to 6 carbon atoms. The cyclic alkylene group is preferably one having 4 to 8 carbon atoms, and more preferably one having 5 to 6 carbon atoms. The cyclic alkyl in the alkylene group containing a cyclic alkyl is preferably one having 4 to 8 carbon atoms, and more preferably one having 5 to 6 carbon atoms. The alkylene group containing a cyclic alkyl is preferably one having 5 to 12 carbon atoms, and more preferably one having 7 to 10 carbon atoms. Examples of the aromatic group include a divalent benzene ring and a divalent naphthalene ring. The alkylene group containing an aromatic group is preferably one having 7 to 14 carbon atoms, and more preferably one having 8 to 12 carbon atoms.

As the compound of General Formula (3), a compound having a single chemical structure may be used, and for example, a plurality of compounds having a different number of n may be used. The molecular weight of the compound of General Formula (3) is preferably from 400 to 2,000, and more preferably from 600 to 1,500, in terms of the weight average molecular weight, n is preferably an integer of 1 to 15, and more preferably an integer of 2 to 10.

As the Si-free compound, a compound having a single chemical structure may be used, and it is preferable to use a plurality of compounds having different chemical structures. It is preferable to use the compound of General Formula (1) and the compound of General Formula (2) in combination, or it is preferable to use the compound of General Formula (1), the compound of General Formula (2) and the compound of General Formula (3) in combination.

Next, the siloxane compound will be described.

The siloxane compound containing a (meth)acrylic group contains a (meth)acrylic group, and thus is copolymerizable with the Si-free compound containing a (meth)acrylic group. As the name implies, the siloxane compound containing a (meth)acrylic group contains a (meth)acrylic group and has a Si—O—Si bond. As the siloxane compound, a compound having a single chemical structure may be used, or a plurality of compounds having different chemical structures may be used.

Specific examples of the siloxane compound include compounds whose basic skeleton is represented by the following General Formula (4). It is to be noted that the compound represented by General Formula (4) may contain an alkoxy group or a hydroxyl group derived from its production process.

(CH₂═CRCO₂C₃H₆SiO_{0.5×3})ₗ(CH₃SiO_{0.5×3})ₘ(SiO_{0.5×4})ₙ (4)

wherein R is independently H or CH₃, the sum of I, m and n is 1, 0.1≤I ≤1, 0≤m≤0.9, and 0≤n≤0.5.

In General Formula (4), R may be either H or CH₃, and CH₃ is preferable. Examples of the range of I include 0.1≤I≤0.8, 0.1≤I≤0.2, and 0.6≤I≤0.8. Examples of the range of m include 0.3≤m≤0.9, 0.2≤m≤0.5, and 0.6≤m≤0.9. Examples of the range of n include 0≤n≤0.4, 0≤n≤0.1, and 0.2≤n≤0.4. Particularly, compounds of 0.9≤I≤1, m=0 and 0≤n≤0.1, those of 0.1≤I≤0.2, 0.8≤m≤0.9 and n=0 or those of 0.05≤I≤0.15, 0.5m≤0.7 and 0.2≤n≤0.4 are preferable.

In the composition of the present disclosure, it is preferable that the Si-free compound and the siloxane compound are blended in an amount of 40 to 95% by mass and 5 to 60% by mass, respectively, based on the total amount of the Si-free compound and the siloxane compound. The blending ratio of the Si-free compound is more preferably from 50 to 90% by mass, and further preferably from 60 to 80% by mass. The blending ratio of the siloxane compound is more preferably from 10 to 50% by mass, and further preferably from 20 to 40% by mass.

Also, when the compound of General Formula (1) and the compound of General Formula (2) are used in combination, it is preferable that the compound of General Formula (1) and the compound of General Formula (2) are blended in an amount of 25 to 55% by mass and 20 to 45% by mass, respectively, and it is more preferable that the compound of General Formula (1) and the compound of General Formula (2) are blended in an amount of 30 to 50% by mass and 25 to 40% by mass, respectively, based on the total amount of the Si-free compound and the siloxane compound.

When the compound of General Formula (1), the compound of General Formula (2) and the compound of General Formula (3) are used in combination, it is preferable that the compound of General Formula (1), the compound of General Formula (2) and the compound of General Formula (3) are blended in an amount of 20 to 50% by mass, 20 to 40% by mass and 5 to 20% by mass, respectively, and it is more preferable that the compound of General Formula (1), the compound of General Formula (2) and the compound of General Formula (3) are blended in an amount of 25 to 40% by mass, 20 to 35% by mass and 10 to 15% by mass, respectively, based on the total amount of the Si-free compound and the siloxane compound.

To the composition of the present disclosure, additives, such as an ultraviolet absorber, a hindered amine light stabilizer, a radical polymerization initiator, a surface conditioner (leveling agent), an organic solvent, a polymerization inhibitor, an antioxidant and an organic polymer may be blended.

By using an ultraviolet absorber, deterioration of the resin substrate due to ultraviolet rays can be suppressed. As the ultraviolet absorber, a known ultraviolet absorber may be used. The ultraviolet absorber may be used alone or in combination of two or more types thereof. The content of the ultraviolet absorber in the composition of the present disclosure is preferably 1 to 12 parts by mass, more preferably 3 to 11 parts by mass, and further preferably 5 to 10 parts by mass, based on 100 parts by mass that is the total amount of the Si-free compound and the siloxane compound.

Specific examples of the ultraviolet absorber include triazine type ultraviolet absorbers, such as
2-[4-[(2-hydroxy-3-dodecyloxypropyl)oxy]-2-hydroxyphenyl]-4,6-bis(2,4-dimethylphenyl)-1,3,5-triazine, 2-[4-[(2-hydroxy-3-tridecyloxypropyl)oxy]-2-hydroxyphenyl]-4,6-bis(2,4-dimethylphenyl)-1,3,5-triazine, 2-[4-[(2-hydroxy-3-(2-ethylhexyloxy)propyl)oxy]-2-hydroxyphenyl]-4,6-bis(2,4-dimethylphenyl)-1,3,5-triazine, 2,4-bis(2-hydroxy-4-butyroxyphenyl)-6-(2,4-bis-butyroxyphenyl)-1,3,5-triazine, and 2-(2-hydroxy-4-[1-octyloxycarbonylethoxy]phenyl)-4,6-bis(4-phenylphenyl)-1,3, 5-triazine; benzotriazole type ultraviolet absorbers, such as 2-(2H-benzotriazol-2-yl)-4,6-bis(1-methyl-1-phenylethyl) phenol, 2-(2-hydroxy-5-tert-butylphenyl)-2H-benzotriazole, and 2-[2-hydroxy-5-(2-(meth)acryloyloxyethyl)phenyl]-2H-benzotriazole; benzophenone type ultraviolet absorbers, such as 2,4-dihydroxybenzophenone and 2-hydroxy-4-methoxybenzophenone; cyanoacrylate type ultraviolet absorbers, such as ethyl-2-cyano-3,3-diphenylacrylate and octyl-2-cyano-3,3-diphenylacrylate; and inorganic fine particles that absorb ultraviolet light, such as titanium oxide fine particles, zinc oxide fine particles, and tin oxide fine particles. Benzotriazole type ultraviolet absorbers having a (meth)acryloyl group are particularly preferable in that weather resistance and abrasion resistance of the film can be preferably satisfied at the same time.

By using a hindered amine light stabilizer, weather resistance of the intermediate layer can be improved. As the hindered amine light stabilizer, a known hindered amine light stabilizer may be used. The hindered amine light stabilizer may be used alone or in combination of two or more types thereof. The content of the hindered amine light stabilizer is preferably 0.05 to 1.5 parts by mass and more preferably 0.1 to 1.5 parts by mass, based on 100 parts by mass that is the total amount of the Si-free compound and the siloxane compound.

Specific examples of the hindered amine light stabilizer include bis(1,2,2,6,6-pentamethyl-4-piperidinyl) sebacate, methyl(1,2,2,6,6-pentamethyl-4-piperidinyl) sebacate, 2,4-bis[N-butyl-N-(1-cyclohexyloxy-2,2,6,6-tetramethylpiperidin-4-yl) amino]-6-(2-hydroxyethylamine)-1,3,5-triazine, and decanedioic acid bis(2,2,6,6-tetramethyl-1-(octyloxy)-4-piperidinyl) ester. Among them, hindered amines having low basicity are preferred in terms of stability of the composition, and specifically, so-called NOR compounds having an amino ether group are more preferable.

By using a radical polymerization initiator, the composition of the present disclosure can be cured quickly. As the radical polymerization initiator, a known photo-radical polymerization initiator and a thermal radical polymerization initiator may be used. The radical polymerization initiator may be used alone or in combination of two or more types thereof. The content of the radical polymerization initiator in the composition of the present disclosure is preferably 0.1 to 10 parts by mass, more preferably 0.5 to 5 parts by mass, and particularly preferably 1 to 3 parts by mass, based on 100 parts by mass that is the total amount of the Si-free compound and the siloxane compound.

Specific examples of the photo-radical polymerization initiator include acetophenone based compounds, such as 2,2-dimethoxy-1,2-diphenylethan-1-one, 1-hydroxycyclohexyl-phenyl-ketone, 2-hydroxy-2-methyl-1-phenyl-propan-1-one, 1-[4-(2-hydroxyethoxy)-phenyl]-2-hydroxy-2-methyl-1-propan-1-one, 2-methyl-1-[4-(methylthio)phenyl]-2-morpholinopropan-1-one, 2-benzyl-2-dimethylamino-1-(4-morpholinophenyl)-butan-1-one, diethoxyacetophenone, oligo{2-hydroxy-2-methyl-1-[4-(1-methylvinyl)phenyl]propanone} and 2-hydroxy-1-{4-[4-(2-hydroxy-2-methylpropionyl)benzyl]phenyl}-2-methyl-prop an-1-one; benzophenone based compounds, such as benzophenone, 4-phenylbenzophenone, 2,4,6-trimethylbenzophenone and 4-benzoyl-4′-methyl-diphenyl disulfide; a-keto ester based compounds, such as 2-(2-oxo-2-phenylacetoxyethoxy)ethyl ester of oxyphenylacetic acid and 2-(2-hydroxyethoxy)ethyl ester of oxyphenylacetic acid; phosphine oxide based compounds, such as 2,4,6-trimethylbenzoyldiphenylphosphine oxide, bis(2,4,6-trimethylbenzoyl)phenylphosphine oxide and bis(2,6-dimethoxybenzoyl)-2,4,4-trimethylpentylphosphine oxide; benzoin based compounds, such as benzoin, benzoin methyl ether, benzoin ethyl ether, benzoin isopropyl ether and benzoin isobutyl ether; titanocene based compounds; acetophenone/benzophenone hybrid type photoinitiators, such as 1-[4-(4-benzoylphenylsulfanyl)phenyl]-2-methyl-2-(4-methylphenylsulfinyl)prop an-1-one; oxime ester type photopolymerization initiators, such as 2-(O-benzoyloxime)-1-[4-(phenylthio)]-1,2-octanedione; and camphor quinone.

Examples of the thermal radical polymerization initiator include organic peroxides, azo based compounds and the like.

Specific examples of the organic peroxide include 1,1-bis(t-butylperoxy)2-methylcyclohexane, 1,1-bis(t-hexylperoxy)-3,3,5-trimethylcyclohexane, 1,1-bis(t-hexylperoxy) cyclohexane, 1,1-bis(t-butylperoxy)-3,3,5-trimethylcyclohexane, 1,1-bis(t-butylperoxy) cyclohexane, 2,2-bis(4,4-di-butylperoxycyclohexyl) propane, 1,1-bis(t-butylperoxy)cyclododecane, t-hexyl peroxyisopropyl monocarbonate, t-butyl peroxymaleic acid, t-butyl peroxy-3,5,5-trimethyl hexanoate, t-butyl peroxylaurate, 2,5-dimethyl-2,5-di(m-toluoylperoxy) hexane, t-butylperoxyisopropyl monocarbonate, t-butylperoxy 2-ethylhexyl monocarbonate, t-hexyl peroxybenzoate, 2,5-dimethyl-2,5-di(benzoylperoxy) hexane, t-butylperoxyacetate, 2,2-bis(t-butylperoxy) butane, t-butyl peroxybenzoate, n-butyl-4,4-bis(t-butylperoxy) valerate, di-t-butylperoxyisophthalate, α,α′-bis(t-butylperoxy) diisopropylbenzene, dicumyl peroxide, 2,5-dimethyl-2,5-di(t-butylperoxy) hexane, t-butylcumyl peroxide, di-t-butyl peroxide, p-menthane hydroperoxide, 2,5-dimethyl-2,5-di(t-butylperoxy) hexyne-3, diisopropylbenzene hydroperoxide, t-butyltrimethylsilyl peroxide, 1,1,3,3-tetramethylbutyl hydroperoxide, cumene hydroperoxide, t-hexyl hydroperoxide, and t-butyl hydroperoxide.

Specific examples of the azo based compound include 1,1′-azobis(cyclohexane-1-carbonitrile), 2-(carbamoylazo)isobutyronitrile, 2-phenylazo-4-methoxy-2,4-dimethylvaleronitrile, azodi-t-octane, and azodi-t-butane.

By using a surface conditioner, the composition of the present disclosure will have a suitable surface smoothness when applied to a resin substrate. As the surface conditioner, a known surface conditioner may be used. The surface conditioner may be used alone or in combination of two or more types thereof. The content of the surface conditioner in the composition of the present disclosure is preferably 0.01 to 1 part by mass and more preferably 0.05 to 0.5 parts by mass, based on 100 parts by mass that is the total amount of the Si-free compound and the siloxane compound.

Specific examples of the surface conditioner include silicone-based surface conditioners having a repeating unit including —[SiR₂O]— and fluorine-based surface conditioners. Note that Rs each independently represent an alkyl group having 1 to 6 carbon atoms.

Examples of the silicone-based surface conditioner include general polysiloxane, dimethylpolysiloxane, EBECRYL 350 (DAICEL-ALLNEX LTD.), BYK-307 (BYK Japan KK), BYK-315 (BYK Japan KK), BYK-349 (BYK Japan KK), BYK-371 (BYK Japan KK), BYK-375 (BYK Japan KK), BYK-378 (BYK Japan KK), EBECRYL 350 (DAICEL-ALLNEX LTD.), EBECRYL 1360 (DAICEL-ALLNEX LTD.), BYK-UV3500 (BYK Japan KK), BYK-UV3530 (BYK Japan KK), BYK-UV3570 (BYK Japan KK), X-22-164 (Shin-Etsu Chemical Co., Ltd.), X-22-164AS (Shin-Etsu Chemical Co., Ltd.), X-22-164A (Shin-Etsu Chemical Co., Ltd.), X-22-164B (Shin-Etsu Chemical Co., Ltd.), X-22-164C (Shin-Etsu Chemical Co., Ltd.), X-22-164E (Shin-Etsu Chemical Co., Ltd.), X-22-174DX (Shin-Etsu Chemical Co., Ltd.), X-22-2426 (Shin-Etsu Chemical Co., Ltd.), X-22-2475 (Shin-Etsu Chemical Co., Ltd.), Toray 8019 (Dow Corning

Toray Co., Ltd.), and Toray 8029 (Dow Corning Toray Co., Ltd.).

Examples of the fluorine-based surface conditioner include MEGAFACE RS-75 (DIC Corporation), MEGAFACE RS-76-E (DIC Corporation), MEGAFACE RS-72-K (DIC Corporation), MEGAFACE RS-76-NS (DIC Corporation), MEGAFACE RS-90 (DIC Corporation), Optool DAC-HP (Daikin Industries, Ltd.), ZX-058-A (T&K TOKA Co., Ltd.), ZX-201 (T&K TOKA Co., Ltd.), ZX-202 (T&K TOKA Co., Ltd.), ZX-212 (T&K TOKA Co., Ltd.), and ZX-214-A (T&K TOKA Co., Ltd.).

It is preferable that an organic solvent is present in the composition of the present disclosure so that the Si-free compound having excellent affinity with the resin substrate can migrate rapidly toward the resin substrate side and the siloxane compound, on the contrary, can migrate rapidly toward the surface side of the composition which is on the side opposite to the resin substrate side, inside the composition of the present disclosure. In addition, when the composition of the present disclosure containing an organic solvent is used, it can be expected that the organic solvent is separated in the drying step and the curing step in the forming of the intermediate layer and that the siloxane compound migrates in the composition to gather at a high concentration near the surface. The organic solvent may be used alone or in combination of two or more types thereof.

Specific examples of the organic solvent include alcohols, such as ethanol and isopropanol; alkylene glycol monoethers, such as ethylene glycol monomethyl ether, propylene glycol monomethyl ether, propylene glycol monoethyl ether, propylene glycol monopropyl ether and propylene glycol monobutyl ether; aromatic compounds, such as toluene and xylene; esters, such as propylene glycol monomethyl ether acetate, ethyl acetate and butyl acetate; ketones, such as acetone, methyl ethyl ketone and methyl isobutyl ketone; ethers, such as dibutyl ether; diacetone alcohol; N-methyl pyrrolidone, and the like. Among them, alkylene glycol monoethers, such as propylene glycol monomethyl ether, are particularly preferable because they are excellent in dispersibility or solubility of their various components, and also do not dissolve the polycarbonate resin in the case where the resin substrate to which the composition is applied is made of a polycarbonate resin.

Further, by using as the organic solvent a mixture of an organic solvent which does not dissolve a polycarbonate resin, such as alcohol or alkylene glycol monoether and an organic solvent which dissolves a polycarbonate resin, such as ester or ketone, it is possible to employ a method that does not dissolve the polycarbonate resin base material during coating and, in the subsequent heating step, dissolves the surface of the resin base material on the order of microns to enhance adhesion to the intermediate layer. Further, by using an organic solvent having various boiling points in combination, it is possible to use a method that enhances the smoothness of the surface of the intermediate layer.

The content of the organic solvent in the composition of the present disclosure is preferably 10 to 1,000 parts by mass, based on 100 parts by mass that is the total amount of the Si-free compound and the siloxane compound. When the blending amount of the organic solvent is too small, it is difficult to apply the composition suitably, and when it is too large, the thickness of the resultant intermediate layer may not be sufficient. Accordingly, the amount of the organic solvent may be selected appropriately according to the coating method. However, in the case of specifying the amount of the organic solvent, it should preferably be 50 to 500 parts by mass and further preferably 50 to 300 parts by mass, from the viewpoint of productivity.

It is preferable to add a polymerization inhibitor to the composition of the present disclosure, for the purpose of improving storage stability. Specific examples of the polymerization inhibitor include hydroquinone, tert-butyl hydroquinone, hydroquinone monomethyl ether, 2,6-di-tert-butyl-4-methylphenol, 2,4,6-tri-tert-butylphenol, benzoquinone, phenothiazine, N-nitrosophenylhydroxylamine, ammonium salts of N-nitrosophenylhydroxylamine, aluminum salts of N-nitrosophenylhydroxylamine, copper dibutyldithiocarbamate, copper chloride, and copper sulfate.

The amount of the polymerization inhibitor to be added in the composition of the present disclosure is preferably 10 to 10,000 ppm and more preferably 100 to 3,000 ppm, based on 100 parts by mass that is the total amount of the Si-free compound and the siloxane compound.

Various antioxidants may be blended into the composition of the present disclosure, for the purpose of improving the heat resistance and weather resistance of the intermediate layer. Examples of the antioxidant include primary antioxidants, such as hindered phenol-based antioxidants and sulfur-based and phosphorus-based secondary antioxidants. The blending amount of the antioxidant is preferably 0 to 5 parts by mass and more preferably 0 to 3 parts by mass, based on 100 parts by mass that is the total amount of the Si-free compound and the siloxane compound.

Specific examples of the primary antioxidant include pentaerythritol tetrakis[3-(3,5-di-tert-butyl-4-hydroxyphenyl)propionate], ethylenebis(oxyethylene)bis[3-(5-tert-butyl-4-hydroxy-m-tolyl)propionate], and 1,3,5-tris[(4-tert-butyl-3-hydroxy-2,6-xyly)methyl]-1,3,5-triazin-2,4,6(1H,3H,5H)-trione.

Specific examples of the secondary antioxidant include didodecyl 3,3′-thiodipropionate, 4,6-bis(octylthiomethyl)-o-cresol, and tris(2,4-di-tert-butylphenyl)phosphite.

The organic polymer and other additives may be blended into the composition of the present disclosure within the scope not departing from the spirit of the present disclosure.

The intermediate layer is formed by disposing a composition containing a Si-free compound containing a (meth)acrylic group and a siloxane compound containing a (meth)acrylic group on a resin substrate, and then curing the composition.

The disposition of the composition may be performed appropriately in accordance with a conventional method, such as coating. For example, a spray method, a spin coating method, a dip coating method, a bar coating method, a flow coating method and the like are preferable, and the method may be selected appropriately in accordance with the shape of a vehicle member or the like. At this time, care should be taken so as not to expose the surface of the resin substrate to a composition containing an organic solvent for a long time, in order to suppress deterioration of the resin substrate by the organic solvent. Although the thickness of the coating film formed by coating depends on the ratio of the solid content contained in the composition, it may be selected appropriately according to the target thickness of the intermediate layer. For example, the thickness of the coating film is preferably 6 to 100 μm.

A drying step of drying the applied composition may be performed between coating and curing. In the drying step, volatile components, such as organic solvent and water are removed by means of natural drying, heat drying, vacuum drying or the like. The temperature for drying may be selected appropriately according to the heat resistance of the resin substrate. For example, the drying temperature may be equal to or lower than the softening point of the resin material of the substrate. Specifically, when the resin substrate is made of polycarbonate, the drying temperature is preferably set in the range of 50 to 120° C.

The curing step is a step of curing the composition (the coating film) to form an intermediate layer on the surface of the resin substrate. Among the compositions, the Si-free compound containing a (meth)acrylic group and the siloxane compound containing a (meth)acrylic group contain terminal olefins. Therefore, energy, such as heat, is imparted to these compositions so that the polymerization reaction proceeds and the compositions are cured. In the case of a composition containing a photo-radical polymerization initiator or a thermal radical polymerization initiator, the composition may be subjected to the conditions under which each polymerization initiator acts. In the case of the composition containing a photo-radical polymerization initiator, the composition may be applied to a resin substrate, and then dried and irradiated with light, such as ultraviolet light. Examples of preferable production method include a method of irradiating the coating film with light after drying under high temperature conditions. The high temperature conditions herein refers to any temperature that is equal to or lower than the temperature that maintains properties of the material of the resin substrate. For example, when the resin substrate is made of polycarbonate, the temperature is preferably in the range of 50 to 120° C., more preferably in the range of 60 to 110° C., further preferably in the range of 70 to 100° C., and particularly preferably in the range of 80 to 100° C.

Examples of the light include ultraviolet light and visible light, and ultraviolet light is particularly preferable. Examples of an ultraviolet irradiation device include high pressure mercury lamps, metal halide lamps, UV electrodeless lamps, LEDs, and the like. In the case of the UV electrodeless lamps, those of new types that use current from a DC power supply may also suitably be used. Irradiation energy should be set appropriately according to the type of active energy rays and the blending composition. When a high pressure mercury lamp is used, for example, the irradiation energy in UV-A region is preferably 100 to 10,000 mJ/cm² and more preferably 1,000 to 6,000 mJ/cm².

When the composition contains a thermal radical polymerization initiator, the composition may be applied to the resin substrate, then dried, and further heated. The temperature for heating is preferably 80 to 200° C., but not particularly limited thereto. The heating temperature may be any temperature as long as it is equal to or lower than the temperature that maintains properties of the material of the resin substrate. The heating time is preferably from 10 minutes or more and 120 minutes or less. From the viewpoint of productivity, the heating time is preferably 60 minutes or less, and further preferably 30 minutes or less.

The curing step may be carried out in the air, or may be carried out in a vacuum or in an inert gas atmosphere. For the performance of the intermediate layer, the curing step is preferably carried out in a vacuum or in an inert gas atmosphere, or may be carried out in the air, in terms of productivity.

For example, when the siloxane compound has an alkoxy group or a hydroxyl group, it is allowable that a photo-radical polymerization initiator is blended into the composition prior to the curing step, and heating is performed in the curing step so that dehydration polymerization involving an alkoxy group or a hydroxyl group proceeds first. In this case, it is preferable to blend a base generator serving as a catalyst for the dehydration polymerization in the composition. It is considered that an increased amount of dehydration polymer of the siloxane compound is present on the surface side opposite to the resin substrate side by proceeding the dehydration polymerization first. As a result, it is expected that the Si concentration on the silicon oxide layer side in the intermediate layer will be markedly higher than that on the resin substrate side.

After the dehydration polymerization, the radical polymerization by light irradiation is started so that the polymerization reaction by a (meth)acrylic group proceeds.

The drying and heating temperatures in the present disclosure correspond to the surface temperature of the coating film, and are approximately equal to the ambient temperature of the drying or heating.

The thickness of the intermediate layer will now be described. Weather resistance improves as the intermediate layer is thicker. However, from the viewpoint of appearance and productivity, it is not preferable to make the intermediate layer markedly thick. Considering weather resistance, appearance and productivity, the film thickness of the intermediate layer is preferably from 5 to 70 μm, and more preferably from 10 to 50 μm.

Next, the silicon oxide layer disposed on the surface of the intermediate layer will be described. The silicon oxide layer contains silicon and oxygen as main components, and is excellent in hardness. The silicon oxide layer may contain carbon and hydrogen derived from raw materials as sub-components. The silicon oxide layer may be formed by a so-called dry coating method, such as a vacuum deposition method, a sputtering method or a chemical vapor deposition method, and may be formed by a so-called wet coating method in which a solution containing an oxygen-containing silicon compound is cured after coating. From the viewpoint of layer uniformity, easiness of process control, adhesion to the intermediate layer and the like, it is preferable to use a chemical vapor deposition method (the CVD method) as a method of forming a silicon oxide layer.

The CVD method for forming a silicon oxide layer is a method of decomposing a raw material gas containing an organosilicon compound to form a thin film containing Si—O on the surface of the intermediate layer. Examples of the organosilicon compound include siloxane compounds, disilazane compounds and silane compounds. Among these compounds, siloxane compounds are particularly preferable.

Examples of the siloxane compound include linear siloxanes, such as 1,1,3,3-tetramethyldisiloxane, pentamethyldisiloxane, hexamethyldisiloxane, 1,1,3,3-tetraphenyl-1,3-dimethyldisiloxane, 1,3-divinyltetramethyldisiloxane, 1,1,3,3,5,5-hexamethyltrisiloxane, 1,1,1,3,5,5,5-heptamethyltrisiloxane, octamethyltrisiloxane, 1,1,1,3,5,7,7,7-octamethyltetrasiloxane, decamethyltetrasiloxane and 1,1,5,5-tetraphenyl-1,3,3,5-tetramethyltrisiloxane; and cyclic siloxanes, such as hexamethylcyclotrisiloxane, 1,3,5,7-tetramethylcyclotetrasiloxane, octamethylcyclotetrasiloxane, decamethylcyclopentasiloxane and 1,3,5,7-tetravinyl-1,3,5,7-tetramethylcyclotetrasiloxane.

Examples of the disilazane compound include 1,1,3,3-tetramethyldisilazane, hexamethyldisilazane, heptamethyldisilazane, hexamethylcyclotrisilazane, and 1,1,3,3,5,5,7,7-octamethylcyclotetrasilazane.

Examples of the silane compound include methylsilane, dimethylsilane, trimethylsilane, tetramethylsilane, trimethoxysilane, triethylsilane, trichloromethylsilane, dichlorodimethylsilane, chlorotrimethylsilane, tetramethoxysilane, trimethoxymethylsilane, ethyltrimethoxysilane, dimethoxydimethylsilane, methoxytrimethylsilane, tetraethoxysilane, triethoxymethylsilane, triethoxyethylsilane, diethoxydimethylsilane, ethoxytrimethylsilane, diethoxymethylsilane, ethoxydimethylsilane, acetoxytrimethylsilane, allyloxytrimethylsilane, allyltrimethylsilane, butoxytrimethylsilane, butyltrimethoxysilane, diacetoxydimethylsilane, dimethoxydiphenylsilane, diethoxydiphenylsilane, dimethoxymethylphenylsilane, ethoxydimethyvinylsilane, diphenylsilanediol, triacetoxymethylsilane, triacetoxyethylsilane, 3-glycidyloxypropyltrimethoxysilane, hexyltrimethoxysilane, 3-mercaptopropyltrimethoxysilane, octadecyltriethoxysilane, triethoxyoctylsilane, triethoxyphenylsilane, trimethylphenylsilane, propoxytrimethylsilane, triethoxypropylsilane, tetraacetoxysilane, tetrabutoxysilane, tetrapropoxysilane, triacetoxyvinylsilane, triethoxyvinylsilane, trimethoxyvinylsilane, triphenylsilanol, trimethylvinylsilane, and tris(2-methoxyethoxy)vinylsilane.

It is preferable to blend a gas containing oxygen, such as O₂ or N₂O into the raw material gas containing an organosilicon compound. Alternatively, a rare gas, such as argon or helium may be blended into the raw material gas as a carrier gas. As a method of decomposing the raw material gas, it is preferable to decompose the raw material gas by using a plasma generating device, depending on the plasma generated under appropriate pressure conditions. A technique for decomposing a raw material gas by using plasma to form a film (layer) is generally referred to as a plasma polymerization method. The silicon oxide layer in the laminate of the present disclosure is preferably formed by a plasma polymerization method.

Examples of the thickness of the silicon oxide layer may include the ranges of 10 nm to 100 μm, 50 nm to 50 μm, 100 nm to 10 μm, and 500 nm to 5 μm.

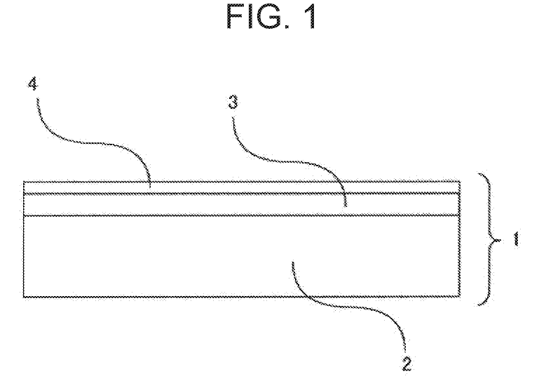

In the laminate of the present disclosure, the intermediate layer disposed on the surface of the resin substrate and the silicon oxide layer disposed on the surface of the intermediate layer serve as protective layers, so that deterioration of the resin substrate is be prevented preferably. Further, the laminate of the present disclosure has the two protective layers for the resin substrate, so that the work and time required for production are reduced. Further, in the laminate of the present disclosure, the intermediate layer having a function of improving the adhesion between the resin substrate and the silicon oxide layer is expected to have a protective function equivalent to that of the conventional art. A schematic side view of the laminate of the present disclosure is shown in FIG. 1. Referring to FIG. 1, a laminate 1 comprises a resin substrate 2, an intermediate layer 3 disposed on a surface of the resin substrate 2, and a silicon oxide layer 4 disposed on a surface of the intermediate layer 3. The laminate of the present disclosure can be used suitably as a material for a vehicle member, such as a windowpane. The vehicle member of the present disclosure includes the laminate of the present disclosure. Examples of the vehicle member include interior and exterior members, outer panels, and resin windows for automobiles, industrial vehicles, personal vehicles, self-propelled vehicle bodies, and railroad vehicles.

Examples of the exterior members include door edge moldings, frames of side mirrors, wheel caps, spoilers, bumpers, turn signal lenses, pillar garnishes, rear finishers, head lamp covers, and the like.

Examples of the interior members include instrument panels, console boxes, instrument panel covers, door lock bezels, steering wheels, power window switch bases, center clusters, dashboards, engine hoods, and the like.

Examples of the outer plates include front fenders, door panels, roof panels, hood panels, trunk lids, back door panels, and the like.

Examples of the resin windows include sunroofs, front windshields, side door windows, rear windshields, rear quarter windows, rear door quarter windows, and the like.

Although the embodiment of the present disclosure has been described above, the present disclosure is not limited to the above embodiment. The present disclosure may be implemented in various embodiments that can be altered and modified by those skilled in the art within the scope not departing from the gist of the present disclosure.

### EXAMPLES

Hereinafter, the present disclosure will be described in more detail by showing examples, comparative examples and the like. It should be noted that the present disclosure is not limited to these examples described herein.

### Production Example 1

Production of Compound of General Formula (1) (HBA)

A 3-L separable flask equipped with a stirrer and an air blowing tube was charged with 1,369.5 g (NCO 7.5 mol) of an isocyanate compound mainly composed of a nurate trimer of hexamethylene diisocyanate [Duranate TPA-100 manufactured by Asahi Kasei Chemicals Corporation, NCO content 23%], 1.22 g of 2,6-di-tert-butyl-4-methylphenol and 0.73 g of dibutyltin dilaurate, and, while stirring the mixture at a liquid temperature of 50 to 70° C., 1,080 g (7.5 mol) of 4-hydroxybutyl acrylate was added dropwise thereto.

After completing the dropwise addition, the mixture was stirred at 80° C. for 4 hours, and the reaction was terminated after confirming that isocyanate groups had disappeared from the reaction solution by IR analysis, thereby obtaining an isocyanuric ring-containing urethane (meth)acrylate compound corresponding to component (A). Hereinafter, this reaction product is referred to as “HBA”.

HBA corresponds to a compound in which R¹, R² and R³ in General Formula (1) are all tetramethylene groups, and R⁴, R⁵ and R⁶ are all hydrogen atoms.

### Production Example 2

Into a flask identical to that in Production Example 1, 290 g of 2-propanol and 248.48 g (1 mol) of 3-methacryloxypropyltrimethoxysilane were charged and then 57.69 g of a 1.6% by mass aqueous tetramethylammonium hydroxide solution (3 mol of water, 10 mmol of tetramethylammonium hydroxide) was gradually added thereto, and the mixture was allowed to react at 25° C. and pH 9 for 1 hour with stirring. Thereafter, 6.62 g of a 10% by mass aqueous nitric acid solution was added to the reaction solution to neutralize. Then, 17.6 mg of Q-1301 (N-nitrosophenyl hydroxylamino aluminum salt) was added as a polymerization inhibitor. Next, the organic solvent and water were distilled off under reduced pressure. Thereafter, the obtained residue was dissolved in diisopropyl ether and washed with water to remove salts and excess acid, and 17.3 mg of the aforesaid polymerization inhibitor was added thereto. Subsequently, from the obtained diisopropyl ether solution, the solvent was distilled off under reduced pressure to obtain a siloxane compound of a pale yellow transparent liquid (liquid having extremely high viscosity and low flowability). The isolated yield was 173.86 g.

The siloxane compound synthesized as described above was analyzed by 1H—NMR, and it was confirmed that a methacryloyl group was present in the siloxane compound.

The content ratio of the alkoxy group (iso-propoxy group bonded to the silicon atom) calculated from the 1H—NMR chart of the obtained siloxane compound corresponded to 0.8% with respect to the whole alkoxy groups contained in the charged raw material.

Also, Mn of the obtained siloxane compound was 2,700. Hereinafter, this siloxane compound is referred to as “PSQ-M”.

PSQ-M is a compound wherein R is CH₃, and I=1 in General Formula (4).

### Example 1

The following were mixed and stirred to prepare a composition of Example 1: 30 Parts by mass of the HBA of Production Example 1 as a Si-free compound; 25 parts by mass of M-315 (trade name ARONIX M-315, manufactured by Toagosei Co., Ltd.) as a Si-free compound; 15 parts by mass of UM-90DA (1/3) (Ube Industries, Ltd.) as a Si-free compound; 30 parts by mass of PSQ3-2 as a siloxane compound; 7.5 parts by mass of RUVA-93 (Otsuka Chemical Co., Ltd.) as an ultraviolet absorber; 1.5 parts by mass of T-479 as an ultraviolet absorber; 0.5 parts by mass of T-123 (BASF

Corporation, trade name TINUVIN 123) as a hindered amine light stabilizer; 2 parts by mass of Irgacure 754 (BASF Corporation) as a photo-radical polymerization initiator; 0.5 parts by mass of Irgacure 819 (BASF Corporation) as a photo-radical polymerization initiator, 0.1 parts by mass of Toray 8019 (Dow Corning Toray Co., Ltd.) as a surface conditioner; and 79.1 parts by mass of propylene glycol monomethyl ether as an organic solvent.

M-315 is tris(acryloyloxyethyl) isocyanurate, and in General Formula (2), R⁷, R⁸ and R⁹ are ethylene groups, R¹⁰, R¹¹ and R¹² are hydrogen atoms, n¹, n² and n³ are 1, and the sum of n¹, n² and n³ is 3.

UM-90DA (1/3) is a compound wherein R is H, L is CH₂-1,4-cyclohexyl-CH₂ or (CH₂)₆ in General Formula (3), and the ratio of CH₂-1,4-cyclohexyl-CH₂ to (CH₂)₆ is 1:3; and the weight average molecular weight is 900.

In the case of PSQ3-2, R is CH₃, I=0.3, m=0.7 in General Formula (4), and the weight average molecular weight is 2,100.

RUVA-93 is 2-[2-hydroxy-5-(2-methacryloyloxyethyl)phenyl]-2H-benzotriazole, T-123 is decanoic acid bis(2,2,6,6-tetramethyl-1-(octyloxy)-4-piperidinyl) ester.

The chemical structure of T-479 is shown below:

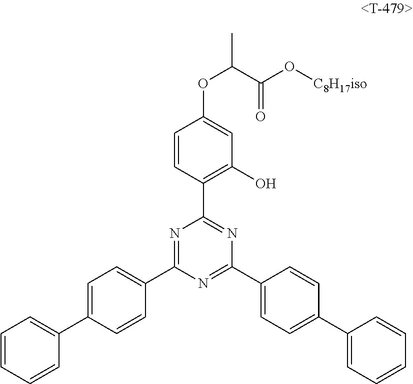

The composition of Example 1 was applied to the surface of a plate-like polycarbonate resin substrate with a bar coater so that the thickness of the coating film after drying was about 15 to 35 μm. Subsequently, after drying for 10 minutes in a hot air dryer at 100° C., ultraviolet irradiation was performed to produce a member of Example 1 having the intermediate layer (thickness of about 10 to 20 μm) of Example 1 on the surface of the resin substrate.

Ultraviolet irradiation was performed using a high-pressure mercury lamp manufactured by EYE Graphics Co., Ltd. The lamp output, the lamp height, and the conveyor speed of the lamp were adjusted so as to achieve a is peak illuminance of 400 mW/cm² and an irradiation energy per pass of 250 mJ/cm² in the UV-A region of a UV POWER PUCK manufactured by Electronic Instrument & Technology, Inc. Irradiation was performed for 12 passes (total 3000 mJ/cm²).

The member of Example 1 was placed in a plasma generating device. Then, a raw material gas containing an organosilicon compound was supplied to the plasma generating device, and a silicon oxide layer was formed on the surface of the intermediate layer of the member of Example 1 by a plasma polymerization method to prepare a laminate of Example 1.

### Example 2

The composition, member and laminate of Example 2 were produced in the same manner as in Example 1, except that PSQ3-6 was used instead of PSQ3-2, as the siloxane compound.

PSQ3-6 is a compound wherein R is CH₃, I=0.2, m=0.8 in General Formula (4), and the weight average molecular weight is 5,100.

### Example 3

The composition, member and laminate of Example 3 were produced in the same manner as in Example 1, except that PSQ3-7 was used instead of PSQ3-2, as the siloxane compound.

PSQ3-7 is a compound wherein R is CH₃, I=0.1, m=0.9 in General Formula (4), and the weight average molecular weight is 5,400.

### Example 4

The composition, member and laminate of Example 4 were produced in the same manner as in Example 1, except that 30 parts by mass of the HBA of Production Example 1 was used as the Si-free compound, 30 parts by mass of M-315 was used as the Si-free compound, 10 parts by mass of UM-90DA (1/3) was used as the Si-free compound, and 30 parts by mass of the PSQ-M of Production Example 2 was used as the siloxane compound, the amount of the organic solvent was changed to 77.6 parts by mass, and T-479 was not used as the ultraviolet absorber.

### Example 5

The composition, member and laminate of Example 5 were produced in the same manner as in Example 4, except that 35 parts by mass of the HBA of Production Example 1 was used as the Si-free compound, 40 parts by mass of M-315 was used as the Si-free compound, and 25 parts by mass of PSQ3-3 was used as the siloxane compound, and the amount of the organic solvent was changed to 110.6 parts by mass, and UM-90DA (1/3) was not used as the Si-free compound.

PSQ3-3 is a compound wherein R is CH₃, I=0.7, m=0.3 in General Formula (4), and the weight average molecular weight is 1,000.

### Example 6

The composition, member and laminate of Example 6 were produced in the same manner as in Example 1, except that PSQ3-3 was used instead of PSQ3-2, as the siloxane compound, the amount of the organic solvent was changed to 110.6 parts by mass, and T-479 was not used as the ultraviolet absorber.

### Example 7

The composition, member and laminate of Example 7 were produced in the same manner as in Example 1, except that PSQ3-3 was used instead of PSQ3-2, as the siloxane compound, and the amount of the organic solvent was changed to 112.1 parts by mass.

### Example 8

The composition, member and laminate of Example 8 were produced in the same manner as in Example 5, except that 30 parts by mass of the HBA of Production Example 1 was used as the Si-free compound, 40 parts by mass of M-315 was used as the Si-free compound, and 30 parts by mass of PSQ3-8 instead of PSQ3-3 was used as the siloxane compound.

PSQ3-8 is a compound wherein R is CH₃, I=0.2, m=0.8 in General Formula (4), and the weight average molecular weight is 2,500.

### Example 9

The composition, member and laminate of Example 9 were produced in the same manner as in Example 8, except that 40 parts by mass of the HBA of Production Example 1 was used as the Si-free compound, 40 parts by mass of M-315 was used as the Si-free compound, and 20 parts by mass of PSQ3-8 was used as the siloxane compound.

### Example 10

The composition, member and laminate of Example 10 were produced in the same manner as in Example 8, except that 50 parts by mass of the HBA of Production Example 1 was used as the Si-free compound, 40 parts by mass of M-315 was used as the Si-free compound, and 10 parts by mass of PSQ3-8 was used as the siloxane compound.

### Example 11

The composition, member and laminate of Example 11 were produced in the same manner as in Example 8, except that PSQ3-9 was used instead of PSQ3-8 as the siloxane compound.

PSQ3-9 is a compound wherein R is CH₃, I=0.1, m=0.6, n=0.3 in General Formula (4), and the weight average molecular weight is 3,400.

### Example 12

The composition, member and laminate of Example 12 were produced in the same manner as in Example 9, except that PSQ3-9 was used instead of PSQ3-8, as the siloxane compound.

### Example 13

The composition, member and laminate of Example 13 were produced in the same manner as in Example 10, except that PSQ3-9 was used instead of PSQ3-8, as the siloxane compound.

### Evaluation Example 1

Analysis on C, O, N and Si was performed on the surface of the intermediate layer in the members of Examples 1 to 13 by using an X-ray photoelectron spectrometer (XPS), and the results of the analysis are shown in Table 1. In Table 1, the ratios of Si element to total elements of C, O, N and Si calculated from the analysis result are listed as the measured %, and the theoretical ratios of Si element to total elements of C, O, N and Si are listed as theoretical %, together with the characteristic components and their compounding ratios in the intermediate layer.

### Evaluation Example 2

A weather resistance test was carried out on the laminates of Examples 1 to 13, using a UV weather resistance tester with a metal halide lamp as a light source. Then, at each elapse of a predetermined time in the weather resistance test, an adhesion test was performed by attaching an adhesive tape to the silicon oxide layer and peeling off the adhesive tape. The weather resistance test was carried out until the silicon oxide layer or the intermediate layer was peeled off in the adhesion test.

The times (hours) at which the silicon oxide layer peeled off with the adhesive tape, or the silicon oxide layer and the intermediate layer peeled off with the adhesive tape in the adhesion test are shown in Test time (h) of Table 1.

TABLE 1

| | Si-Free compound | | | | | | Test |
|---|---|---|---|---|---|---|---|
| | | | UM-90DA | Siloxane | Ratio of Si element | | time |
| | HBA | M-315 | (1/3) | compound | Theoretical | Measured | (h) |
| Example 1 | 30 | 25 | 15 | PSQ3-2 | 3.3 | 10.5 | 156 |
| | | | | 30 | | | |
| Example 2 | 30 | 25 | 15 | PSQ3-6 | 3.6 | 16.8 | 672 |
| | | | | 30 | | | |
| Example 3 | 30 | 25 | 15 | PSQ3-7 | 3.8 | 8.6 | 372 |
| | | | | 30 | | | |
| Example 4 | 30 | 30 | 10 | SQ3-M | 3.0 | 12.2 | 468 |
| | | | | 30 | | | |
| Example 5 | 35 | 40 | — | PSQ3-3 | 2.0 | 6.3 | 108 |
| | | | | 25 | | | |
| Example 6 | 30 | 25 | 15 | PSQ3-3 | 2.6 | 8.2 | 108 |
| | | | | 30 | | | |
| Example 7 | 30 | 25 | 15 | PSQ3-3 | 2.6 | 8.7 | 108 |
| | | | | 30 | | | |
| Example 8 | 30 | 40 | — | PSQ3-8 | 3.6 | 11.4 | 60 |
| | | | | 30 | | | |
| Example 9 | 40 | 40 | — | PSQ3-8 | 2.4 | 9.0 | 60 |
| | | | | 20 | | | |
| Example 10 | 50 | 40 | — | PSQ3-8 | 1.3 | 5.6 | 60 |
| | | | | 10 | | | |
| Example 11 | 30 | 40 | — | PSQ3-9 | 3.7 | 13.6 | 588 |
| | | | | 30 | | | |
| Example 12 | 40 | 40 | — | PSQ3-9 | 2.5 | 10.2 | 108 |
| | | | | 20 | | | |
| Example 13 | 50 | 40 | — | PSQ3-9 | 1.3 | 6.7 | 60 |
| | | | | 10 | | | |

As can be seen from the results in Ratio of Si element of Table 1, in every example, the measured value of the ratio of Si element on the silicon oxide layer side in the intermediate layer is higher than the theoretical value. From these results, it can be said that, in each example, the concentration of Si on the silicon oxide layer side in the intermediate layer is higher than that on the resin substrate side. From the results in Measured % of the ratio of Si element and Test time (h) of Table 1, it can be said that weather resistance tends to increase as the value of the measured % of the ratio of Si element increases. Hereinafter, the results of Table 1 will be examined in detail.

The difference between Example 1, Example 2, Example 3 and Example 6 is only the type of the siloxane compound, and the weather resistance is excellent in the order of Example 2, Example 3, Example 1, and Example 6. In addition, Example 2 and Example 3 are markedly superior to Example 1 and Example 6 in weather resistance.

PSQ3-2 that is the siloxane compound used in Example 1 is a compound wherein I=0.3, m=0.7 in General Formula (4), and the weight average molecular weight is 2,100.

PSQ3-6 that is the siloxane compound used in Example 2 is a compound wherein I=0.2, m=0.8 in General Formula (4), and the weight average molecular weight is 5,100.

PSQ3-7 that is the siloxane compound used in Example 3 is a compound wherein I=0.1, m=0.9 in General Formula (4), and the weight average molecular weight is 5,400.

PSQ3-3 that is the siloxane compound used in Example 6 is a compound wherein I=0.7, m=0.3 in General Formula (4), and the weight average molecular weight is 1,000.

Thus, from the results of Example 1, Example 2, Example 3 and Example 6, it can be said that, as the siloxane compound, those having I=0.1 to 0.2, m 32 0.8 to 0.9 in General Formula (4), and the weight average molecular weight is about 5,000 to 5,500, are particularly suitable.

PSQ-M that is the siloxane compound used in Example 4 is a compound wherein I=1 in General Formula (4), Since the weather resistance of Example 4 is preferable, it can be said that compounds having I that is around 1 are also suitable as the siloxane compounds.

The major difference between Example 5 and Example 6 is that, as the Si-free compound, two types of compounds, namely, HBA and M-315, were used in Example 5, whereas three types of compounds, namely, HBA, M-315 and UM-90DA (1/3), were used in Example 6. However, the weather resistances were equal in the Example 5 and Example 6, Therefore, from the results of Example 5 and Example 6, it can be said that the three types of Si-free compounds, HBA, M-315 and UM-90DA (1/3), exhibit roughly equivalent properties in terms of the weather resistance.

The difference between Example 6 and Example 7 is that 7.5 parts by mass of one type of ultraviolet absorber was used in Example 6, whereas a total of 9 parts by mass of two types of ultraviolet absorbers was used in Example 7, However, the weather resistance of both was equal. Therefore, from the results of Example 6 and Example 7, it can be said that a change in the type and blending amount of the ultraviolet absorber has a little influence on the weather resistance of the laminate.

The groups of Examples 8 to 10 and the groups of Examples 11 to 13 differ in the type of the siloxane compound. It can be seen that weather resistances are equivalent irrespective of the variation in the blending amount of the siloxane compound in Examples 8 to 10, whereas weather resistance is further improved along with the increase in the blending amount of the siloxane compound in Examples 11 to 13.

PSQ3-8 that is the siloxane compound used in Examples 8 to 10 is a compound wherein I=0.2, m=0.8 in General Formula (4), and the weight average molecular weight is 2,500.

PSQ3-9 that is the siloxane compound used in Examples 11 to 13 is a compound wherein I=0.1, m=0.6, n=0.3 in General Formula (4), and the weight average molecular weight is 3,400.

From the results of Examples 8 to 10 and Examples 11 to 13, it can be said that compounds having n that is around 0.3 in General Formula (4) are preferable as the siloxane compounds.

From the results of Examples 11 to 13, it can be said that the siloxane compound is blended preferably in an amount of 20 to 40% by mass, and is blended particularly preferably in an amount of 25 to 35% by mass, based on the total amount of the Si-free compound and the siloxane compound.

What is claimed is:

1. A laminate comprising:
a resin substrate;
an intermediate layer disposed on a surface of the resin substrate; and
a silicon oxide layer disposed on a surface of the intermediate layer, wherein
the intermediate layer is formed by curing a composition containing a Si-free compound containing a (meth)acrylic group and a siloxane compound containing a (meth)acrylic group, and
a concentration of Si is higher on a silicon oxide layer side than a concentration of Si on a resin substrate side in the intermediate layer.

2. The laminate according to claim 1, wherein the Si concentration of a surface on the silicon oxide layer side in the intermediate layer is 2 to 10 times a theoretical Si concentration in the intermediate layer.

3. The laminate according to claim 1, wherein, when the surface on the silicon oxide layer side in the intermediate layer is subjected to an element analysis by X-ray photoelectron spectroscopy for C, O, N and Si, a ratio of Si element to total elements of C, O, N and Si is 5% or more.

4. The laminate according to claim 1, wherein, in the composition, the Si-free compound is contained in an amount of 40 to 95% by mass and the siloxane compound is contained in an amount of 5 to 60% by mass, based on a total amount of the Si-free compound and the siloxane compound.

5. The laminate according to claim 1, wherein the Si-free compound contains an isocyanuric ring or a carbonate structure, and contains two or more (meth)acrylic groups.

6. The laminate according to claim 1, wherein
the Si-free compound is an isocyanuric ring-containing urethane (meth)acrylate compound represented by General Formula (1) and/or an isocyanuric ring-containing tri(meth)acrylate compound having no urethane bond represented by General Formula (2); 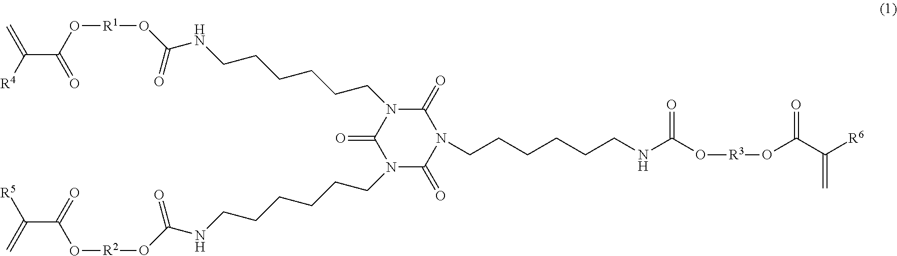
wherein, in General Formula (1), R¹, R² and R³ each independently represent a divalent organic group having 2 to 10 carbon atoms; and R⁴, R⁵ and R⁶ each independently represent a hydrogen atom or a methyl group, 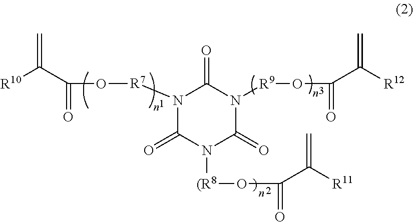
wherein, in General Formula (2), R⁷, R⁸ and R⁹ each independently represent a divalent organic group having 2 to 10 carbon atoms; R¹⁰, R¹¹ and R¹² each independently represent a hydrogen atom or a methyl group; n¹, n² and n³ each independently represent a number from 1 to 3; and a sum of n¹, n² and n³ is 3 to 9.

7. The laminate according to claim 1, wherein
the Si-free compound contains a carbonate structure-containing (meth)acrylate compound represented by General Formula (3):
CH₂═CRCO₂[—LOCOO]ₙ—L—OCOCR═CH₂ (3)
wherein Rs are each independently H or CH₃, Ls are each independently a divalent hydrocarbon having two or more carbon atoms, and n is an integer of 1 or more.

8. The laminate according to claim 1, wherein
a basic skeleton of the siloxane compound is represented by General Formula (4):
(CH₂═CRCO₂C₃H₆SiO_{0.5×3})ₗ(CH₃SiO_{0.5×3})ₘ(SiO_{0.5×4})ₙ , (4)
wherein R is independently H or CH₃, the sum of I, m and n is 1; 0.1≤1 ≤1; 0≤m≤0.9; and 0≤n≤0.5.

9. The laminate according to claim 1, wherein the resin substrate is made of polycarbonate.

10. A vehicle member comprising a laminate, the laminate comprising:
a resin substrate;
an intermediate layer disposed on a surface of the resin substrate; and
a silicon oxide layer disposed on a surface of the intermediate layer, wherein
the intermediate layer is formed by curing a composition containing a Si-free compound containing a (meth)acrylic group and a siloxane compound containing a (meth)acrylic group, and
a concentration of Si is higher on a silicon oxide layer side than a concentration of Si on a resin substrate side in the intermediate layer.

11. A composition containing:
a Si-free compound containing two or more (meth)acrylic groups, and an isocyanuric ring or a carbonate structure; and
a siloxane compound having a basic skeleton represented by General Formula (4):
(CH₂═CRCO₂C₃H₆SiO_{0.5×3})ₗ(CH₃SiO_{0.5×3})ₘ(SO_{0.5×4})ₙ (4)
wherein R is independently H or CH₃, the sum of I, m and n is 1, 0.1≤I ≤1, 0≤m≤0.9, and 0≤n≤0.5,
wherein the composition contains 40 to 95% by mass of the Si-free compound and 5 to 60% by mass of the siloxane compound, based on a total amount of the Si-free compound and the siloxane compound.

12. The composition according to claim 11, wherein the Si-free compound is an isocyanuric ring-containing urethane (meth)acrylate compound represented by General Formula (1) and/or an isocyanuric ring-containing tri(meth)acrylate compound having no urethane bond represented by General Formula (2): 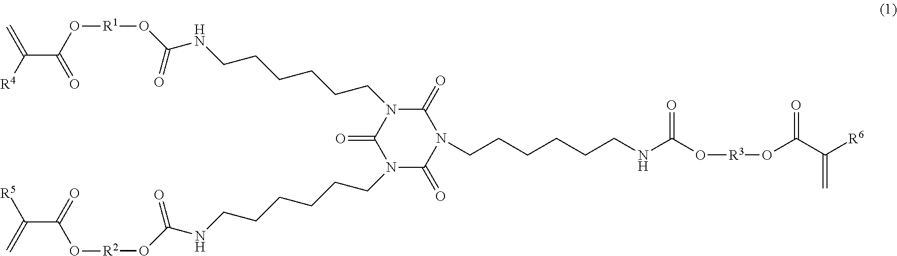
wherein, in General Formula (1), R¹, R² and R³ each independently represent a divalent organic group having 2 to 10 carbon atoms; and R⁴, R⁵ and R⁶ each independently represent a hydrogen atom or a methyl group, 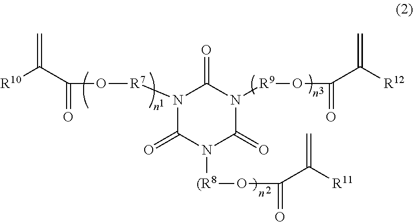
wherein, in General Formula (2), R⁷, R⁸ and R⁹ each independently represent a divalent organic group having 2 to 10 carbon atoms; R¹⁰, R¹¹ and R¹² each independently represent a hydrogen atom or a methyl group; n¹, n² and n³ each independently represent a number from 1 to 3; and a sum of n¹, n² and n³ is 3 to 9.

13. The composition according to claim 11, wherein the Si-free compound comprises a carbonate structure-containing (meth)acrylate compound represented by General Formula (3):
CH₂═CRCO₂[-LOCOO]ₙ-L-OCOCR═CH₂ (3)
wherein Rs are each independently H or CH₃; Ls are each independently a divalent hydrocarbon having two or more carbon atoms; and n is an integer of 1 or more,
